(19) United States
(12) Patent Application Publication
(10) Pub. No.: US 2026/0298790 A1
(43) Pub. Date: Oct. 1, 2026

(54) TEST FIXTURE

(71) Applicant: SYNCMOLD ENTERPRISE CORP., New Taipei City (TW)

(72) Inventors: Chun-Hao Huang, New Taipei City (TW); Chien-Cheng Yeh, New Taipei City (TW)

(21) Appl. No.: 19/550,381

(22) Filed: Feb. 26, 2026

Related U.S. Application Data
(60) Provisional application No. 63/779,610, filed on Mar. 28, 2025.

(30) Foreign Application Priority Data
Oct. 28, 2025 (TW) 114141686

(51) Int. Cl. G01N 3/34; G01M 99/00

(52) U.S. Cl. CPC G01N 3/34; G01M 99/007; G01N 2203/0005; G01N 2203/0023

(57) ABSTRACT

A test fixture of the present disclosure is provided and comprises: a first platform member; a first drop plate pivotally connected to the first platform member and including at least one first pin; a second platform member; a second drop plate pivotally connected to the second platform member and including at least one second pin; at least one first limiting member fixedly connected to the second platform member and abutted against by the first pin; and at least one second limiting member fixedly connected to the first platform member and abutted against by the second pin; wherein when the first platform member and the second platform member are in a folded state, the first drop plate and the first platform member are obliquely intersected at a first angle, and the second drop plate and the second platform member are obliquely intersected at a second angle.

### CROSS-REFERENCE TO RELATED APPLICATIONS

This application claims the benefit of U.S. Provisional Application Ser. No. 63/779,610 filed on Mar. 28, 2025, and the benefit of Taiwan Patent Application Serial No. 114141686 filed on Oct. 28, 2025. The entirety of each Application is incorporated herein by reference.

### BACKGROUND

### 1. Technical Field

The present disclosure relates to a test fixture, and more particularly, to a test fixture utilized to test a lifespan of a flexible screen.

### 2. Description of Related Art

A flexible screen of a foldable electronic device is required to be frequently bent, and therefore a lifespan of the flexible screen, bent via a connecting rod structure, has to be increased as much as possible. However, there is currently no test fixture on the market capable of testing the lifespan of the flexible screen when bent into a water drop shape, let alone a customized test fixture for different water drop sizes of the flexible screen.

### SUMMARY

A test fixture is provided for testing a lifespan of a flexible screen and comprises: a first platform member including at least one first pivot portion and at least one first slot; a first drop plate pivotally connected to the first pivot portion, being rotatable relative to the first platform member, and including at least one first pin; a second platform member including at least a second pivot portion and at least a second slot; a second drop plate adjacent to the first drop plate, pivotally connected to the second pivot portion, being rotatable relative to the second platform member, and including at least one second pin; at least one first limiting member fixedly connected to the second platform member and passing through the first slot, wherein the first pin abuts against the first limiting member; and at least one second limiting member fixedly connected to the first platform member and passing through the second slot, wherein the second pin abuts against the second limiting member; wherein the first platform member and the second platform member are transformable between an unfolded state and a folded state, wherein when the first platform member and the second platform member are in the unfolded state, the first platform member, the second platform member, the first drop plate and the second drop plate are flush with each other, and wherein when the first platform member and the second platform member are in the folded state, the first platform member and the second platform member are adjacent to and are parallel to each other, the first drop plate and the first platform member are obliquely intersected at a first angle, and the second drop plate and the second platform member are obliquely intersected at a second angle.

In the aforementioned test fixture, wherein when the first platform member and the second platform member transform from the unfolded state to the folded state, the first angle and the second angle gradually increase, and wherein when the first platform member and the second platform member transform from the folded state to the unfolded state, the first angle and the second angle gradually decrease.

In the aforementioned test fixture, which further comprises at least one first elastic element and at least one second elastic element, wherein opposite ends of the first elastic element are respectively fixedly connected to the first platform member and the first drop plate to constantly provide a first elastic force, and wherein opposite ends of the second elastic element are respectively fixedly connected to the second platform member and the second drop plate to constantly provide a second elastic force.

In the aforementioned test fixture, wherein the first limiting member includes a first fixing portion and a first hook portion, the first fixing portion is fixedly connected to the second platform member, the first hook portion is formed by extending outward from the first fixing portion and bending to pass through the first slot, and the first elastic force keeps the first pin continuously abutting against the first hook portion, and wherein the second limiting member includes a second fixing portion and a second hook portion, the second fixing portion is fixedly connected to the first platform member, the second hook portion is formed by extending outward from the second fixing portion and bending to pass through the second slot, and the second elastic force keeps the second pin continuously abutting against the second hook portion.

In the aforementioned test fixture, wherein the first platform member further includes at least one first stop block and at least one first stop rod, the first stop block is adjacent to the first pivot portion, and the first stop rod and the first stop block are spaced apart from each other, wherein the second platform member further includes at least one second stop block and at least one second stop rod, the second stop block is adjacent to the second pivot portion, and the second stop rod and the second stop block are spaced apart from each other, wherein when the first platform member and the second platform member are in the unfolded state, the first drop plate abuts against the first stop block, and the second drop plate abuts against the second stop block, and wherein when the first platform member and the second platform member are in the folded state, the first drop plate abuts against the first stop rod, and the second drop plate abuts against the second stop rod.

In the aforementioned test fixture, wherein the first hook portion and the second hook portion respectively include an irregular curvature, depending on different angles of rotation of the first platform member or the second platform member from the unfolded state to the folded state, the first pin or the second pin abuts against different positions of the first hook portion or the second hook portion, whereby the first angle or the second angle varies non-linearly.

In the aforementioned test fixture, wherein when the first platform member and the second platform member are respectively rotated by 30 degrees from the unfolded state to the folded state, the first angle and the second angle are 6.2 degrees, wherein when the first platform member and the second platform member are respectively rotated by 50 degrees from the unfolded state to the folded state, the first angle and the second angle are 8.7 degrees, wherein when the first platform member and the second platform member are respectively rotated by 70 degrees from the unfolded state to the folded state, the first angle and the second angle are 9.7 degrees, and wherein when the first platform member and the second platform member are respectively rotated by 90 degrees from the unfolded state to be in the folded state, the first angle and the second angle are 10 degrees.

In the aforementioned test fixture, wherein the first elastic element and the second elastic element are tension springs.

In the aforementioned test fixture, wherein in the folded state, a distance between the first platform member and the second platform member is equal to or is less than a distance between the first drop plate and the second drop plate.

In the aforementioned test fixture, wherein the flexible screen is disposed on the first platform member, the first drop plate, the second platform member and the second drop plate, wherein the flexible screen includes a bendable area, and wherein when the first platform member and the second platform member are in the folded state, the bendable area of the flexible screen is bent, and the first drop plate and the second drop plate jointly define an accommodation space to accommodate the bendable area.

In the aforementioned test fixture, wherein the bendable area has a water drop shape.

As described above, when the first platform member and the second platform member are rotated at different angles, the first angle and the second angle correspond to specific values in manners of the first hook portion and the second hook portion being designed with irregular curvatures, and the first pin and the second pin being continuously abutting against the first hook portion and the second hook portion via the first elastic elements and the second elastic elements. Accordingly, the test fixture of the present disclosure can effectively test a lifespan of a flexible screen, and the customized design of the irregular curvatures of the first hook portion and the second hook portion can accommodate the flexible screen in different bending conditions.

### BRIEF DESCRIPTION OF THE DRAWINGS

FIG. 1 and FIG. 2 are overall schematic views of different perspectives of a test fixture in an unfolded state according to the present disclosure.

FIG. 3 is an exploded schematic view of the test fixture according to the present disclosure.

FIG. 4 is an exploded schematic view of a first drop plate and a second drop plate of the test fixture according to the present disclosure.

FIG. 5 is a cross-sectional schematic view taken along a line A-A in FIG. 1.

FIG. 6 is a cross-sectional schematic view taken along a line B-B in FIG. 1.

FIG. 7 is a cross-sectional schematic view taken along a line C-C in FIG. 1.

FIG. 8 is a cross-sectional schematic view taken along a line D-D in FIG. 1.

FIG. 9 is a cross-sectional schematic view of the test fixture in a folded state corresponding to FIG. 5 according to the present disclosure.

FIG. 10 is a cross-sectional schematic view of the test fixture in the folded state corresponding to FIG. 6 according to the present disclosure.

FIG. 11 is a cross-sectional schematic view of the test fixture in the folded state corresponding to FIG. 7 according to the present disclosure.

FIG. 12 is a cross-sectional schematic view of the test fixture in the folded state corresponding to FIG. 8 according to the present disclosure.

FIG. 13 is a cross-sectional schematic view of the test fixture in a first intermediate state according to the present disclosure.

FIG. 14 is a cross-sectional schematic view of the test fixture in a second intermediate state according to the present disclosure.

FIG. 15 is a cross-sectional schematic view of the test fixture in a third intermediate state according to the present disclosure.

FIG. 16 is an exploded schematic view of the test fixture and a driving platform according to the present disclosure.

### DETAILED DESCRIPTION

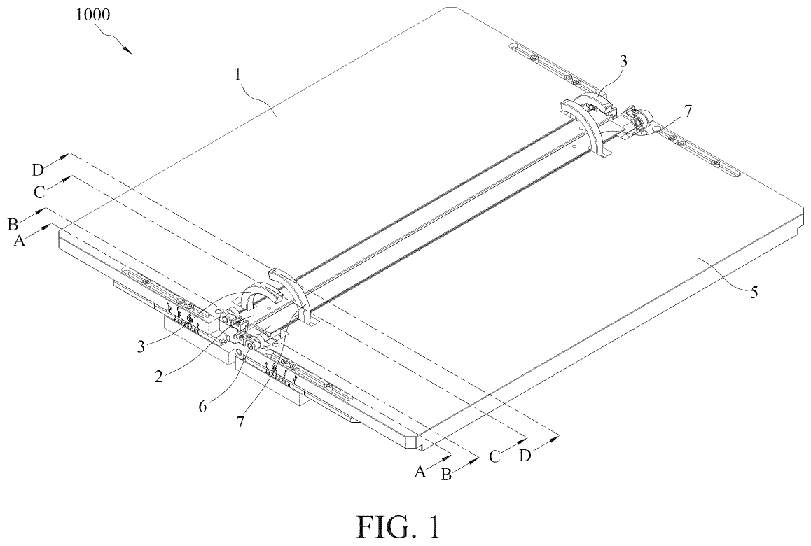

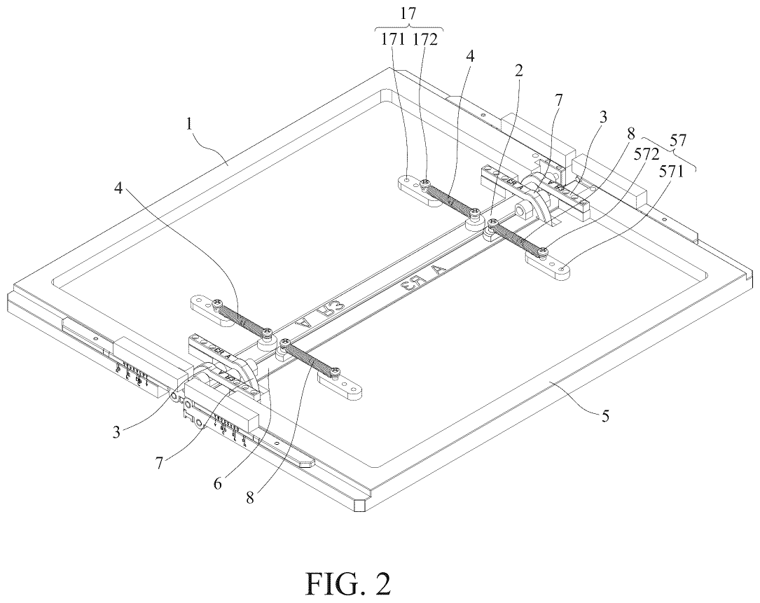

Please refer to FIG. 1 and FIG. 2, a test fixture 1000 of the present disclosure comprises a first platform member 1, a first drop plate 2, two first limiting members 3, two first elastic elements 4, a second platform member 5, a second drop plate 6, two second limiting members 7 and two second elastic elements 8. The first drop plate 2 is pivotally connected to the first platform member 1, the second drop plate 6 is pivotally connected to the second platform member 5. The first platform member 1 and the second platform member 5 are arranged side by side such that the first drop plate 2 is adjacent to the second drop plate 6, the first drop plate 2 and the second drop plate 6 are interposed between the first platform member 1 and the second platform member 5. The first limiting members 3 are fixedly connected to the second platform member 5, the second limiting members 7 are fixedly connected to the first platform member 1, the first elastic elements 4 are connected to the first platform member 1 and the first drop plate 2, and the second elastic elements 8 are connected to the second platform member 5 and the second drop plate 6.

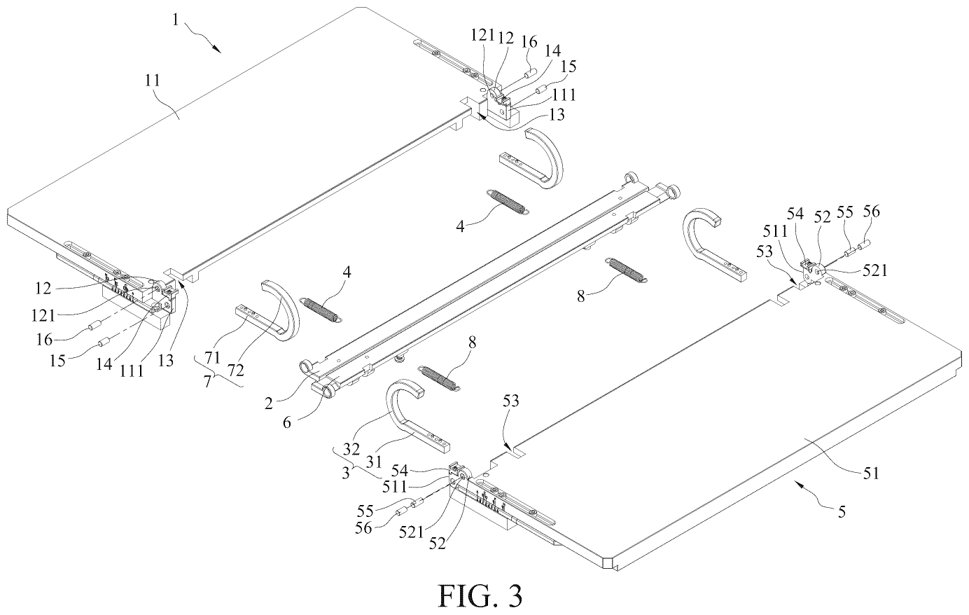

Please further refer to FIG. 3, the first platform member 1 includes a first body 11, two first pivot portions 12, two first slots 13, two first stop blocks 14, two first stop rods 15, two first shafts 16 and two first adjustable portions 17. The first body 11 is generally in a shape of a square plate and has two first extension blocks 111. The first pivot portions 12 are respectively formed on the first extension blocks 111 of the first body 11, and each of the first pivot portions 12 has a first pivot joint hole 121. The first slots 13 are spaced apart from each other and are formed on the first body 11. The first stop blocks 14 are respectively fixedly connected to the first extension blocks 111 and are adjacent to the first pivot portions 12. The first stop rods 15 respectively penetrate through the first extension blocks 111 and are respectively spaced apart from the first stop blocks 14. The first shafts 16 respectively pass through the first pivot joint holes 121. The first adjustable portions 17 are respectively formed on a bottom side of the first body 11, and each of the first adjustable portions 17 has a plurality of first locking holes 171 and a first screw 172, wherein the first screw 172 can be secured in one of the first locking holes 171.

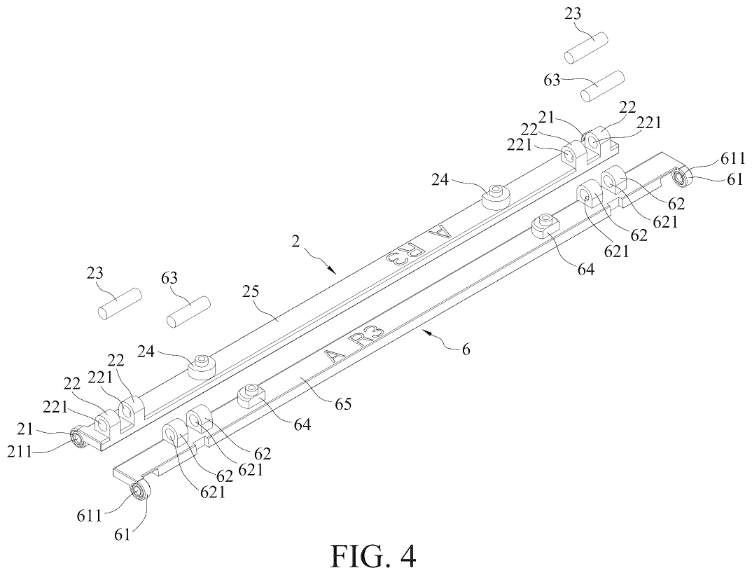

Please also refer to FIG. 4, the first drop plate 2 includes two first pivoting portions 21, four first connecting rod portions 22, two first pins 23, two first fastening portions 24 and a first plate 25. The first plate 25 is generally in a shape of a long strip. The first pivoting portions 21 respectively extend outward from opposite ends of the first plate 25, and each of the first pivoting portions 21 has a first pivoting hole 211. The first shafts 16 respectively pass through the first pivoting holes 211, whereby the first drop plate 2 rotates relative to the first platform member 1 about the first shafts 16 as an axis. The first connecting rod portions 22 are formed on a bottom side of the first plate 25 in pairs, and each of the first connecting rod portions 22 has a first rod hole 221. The first pins 23 pass through the first rod holes 221 and are partially exposed from the first connecting rod portions 22. The first fastening portions 24 are spaced apart from each other and are formed on the bottom side of the first plate 25.

The first limiting members 3 are generally in a shape of a fishhook, and respectively include a first fixing portion 31 and a first hook portion 32. The first fixing portion 31 is generally in a shape of a long strip, being fixedly connected to a bottom side of the second platform member 5. The first hook portion 32 is formed by extending outward from the first fixing portions 31 and bending (for example, first extending and bending toward the first platform member 1 and then bending and extending toward the second platform member 5) to pass through the first slot 13, and has an irregular curvature. Opposite ends of the first elastic element 4 are respectively fixedly connected to the first screws 172 of the first adjustable portions 17 and the first fastening portions 24 of the first drop plate 2 (via screws), thereby constantly providing a first elastic force. The first elastic force keeps the first pins 23 continuously abutting against the first hook portions 32. By securing the first screws 172 in different ones of the first locking holes 171, the magnitude of the first elastic force can be adjusted. The first elastic elements 4 can be tension springs.

The second platform member 5 includes a second body 51, two second pivot portions 52, two second slots 53, two second stop blocks 54, two second stop rods 55, two second shafts 56 and two second adjustable portions 57. The second body 51 is generally in a shape of a square plate and has two second extension blocks 511. The second pivot portions 52 are respectively formed on the second extension blocks 511 of the second body 51, and each of the second pivot portions 52 has a second pivot joint hole 521. The second slots 53 are spaced apart from each other and are formed on the second body 51. The second stop blocks 54 are respectively fixedly connected to the second extension blocks 511 and are adjacent to the second pivot portions 52. The second stop rods 55 respectively penetrate through the second extension blocks 511 and are spaced apart from the second stop blocks 54. The second shafts 56 respectively pass through the second pivot joint holes 521. The second adjustable portions 57 are respectively formed on a bottom side of the second body 51, and each of the second adjustable portions 57 has a plurality of second locking holes 571 and a second screw 572, wherein the second screw 572 can be secured in one of the second locking holes 571.

The second drop plate 6 includes two second pivot portions 61, four second connecting rod portions 62, two second pins 63, two second fastening portions 64 and a second plate 65. The second plate 65 is generally in a shape of a long strip. The second pivoting portions 61 respectively extend outward from opposite ends of the second plate 65, and each of the second pivoting portions 61 has a second pivoting hole 611. The second shafts 56 respectively pass through the second pivoting holes 611, whereby the second drop plate 6 rotates relative to the second platform member 5 about the second shafts 56 as an axis. The second connecting rod portions 62 are formed on a bottom side of the second plate 65 in pairs, and each of the second connecting rod portions 62 has a second rod hole 621. The second pins 63 pass through the second rod holes 621 and are partially exposed from the second connecting rod portions 62. The second fastening portions 64 are spaced apart from each other and are formed at the bottom of the second plate 65.

The second limiting members 7 are generally in a shape of a fishhook, and respectively include a second fixing portion 71 and a second hook portion 72. The second fixing portion 71 is generally in a shape of a long strip, being fixedly connected to the bottom of the first platform member 1. The second hook portion 72 is formed by extending outward from the second fixing portions 71 (for example, first extending and bending toward the second platform member 5 and then bending and extending toward the first platform member 1) to pass through the second slot 53, and has an irregular curvature (identical to the first hook portions 32). Opposite ends of the second elastic element 8 are respectively fixedly connected to the second screw 572 of the second adjustable portions 57 and the second fastening portion 64 of the second drop plate 6 (via a screw), thereby constantly providing a second elastic force. The second elastic force keeps the second pins 63 continuously abutting against the second hook portions 72. By securing the second screws 572 in different ones of the second locking holes 571, the magnitude of the second elastic force can be adjusted. The second elastic elements 8 can be tension springs.

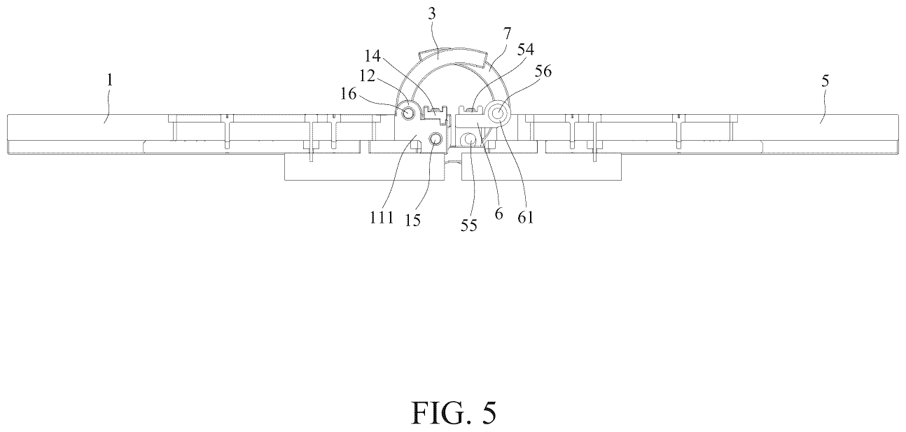

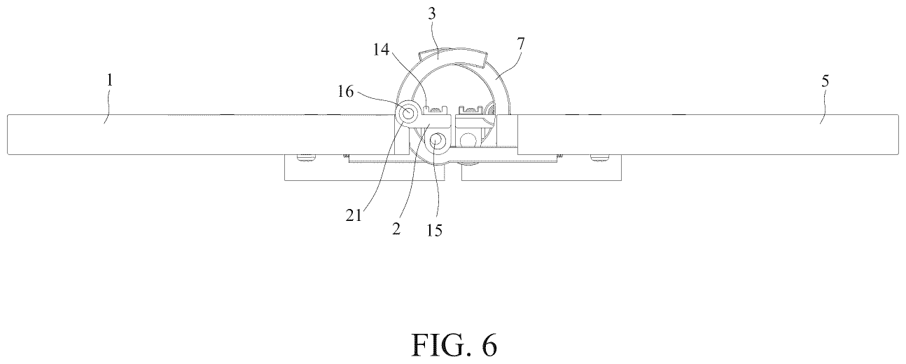

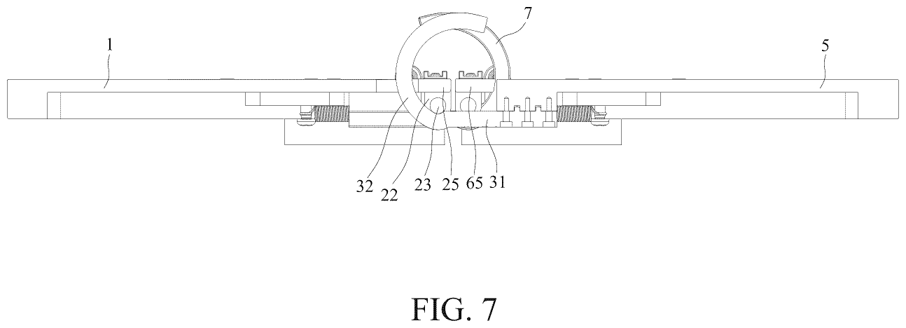

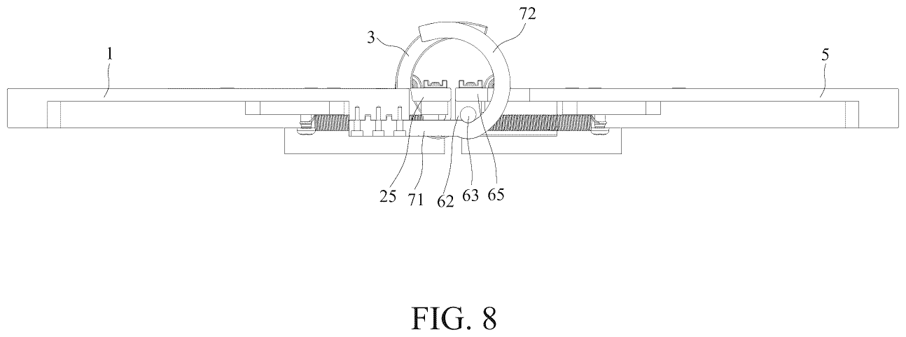

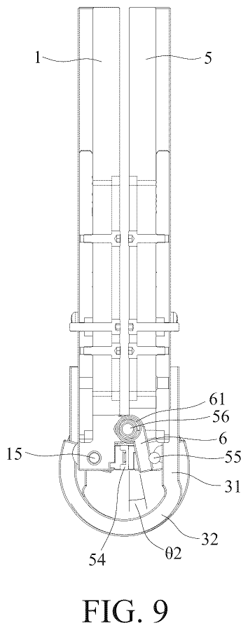

The following describes the operation of the test fixture 1000 disclosed herein. The first platform member 1 and the second platform member 5 are transformable between an unfolded state (FIG. 5 to FIG. 8) and a folded state (FIG. 9 to FIG. 12). In the unfolded state, the upper surfaces of the first platform member 1, the second platform member 5, the first drop plate 2 and the second drop plate 6 are flush with each other. At this time, the first drop plate 2 abuts against the first stop blocks 14 and is away from the first stop rods 15 (FIG. 6), the second drop plate 6 abuts against the second stop blocks 54 and is away from the second stop rods 55 (FIG. 5), the first pins 23 abut against parts of the first hook portions 32 adjacent to the first fixing portions 31 (FIG. 7), and the second pins 63 abut against parts of the second hook portions 72 adjacent to the second fixing portions 71 (FIG. 8).

When the first platform member 1 and the second platform member 5 transform from the unfolded state to the folded state, depending on different angles of rotation of the first platform member 1, the first pins 23 abut against different positions of the first hook portions 32. Because of irregular curvatures of the first hook portions 32, when the first pins 23 abut against different positions of the first hook portions 32, an upper surface of the first platform member 1 and an upper surface of the first drop plate 2 change from being flush with each other to being obliquely intersected at a first angle θ1, and the first angle θ1 varies with the positions of the first hook portion 32 abutted against by the first pins 23. Similarly, depending on different angles of rotation of the second platform member 5, the second pins 63 abut against different positions of the second hook portions 72. Because of irregular curvatures of the second hook portions 72, when the second pins 63 abut against different positions of the second hook portions 72, an upper surface of the second platform member 5 and an upper surface of the second drop plate 6 change from being flush with each other to being obliquely intersected at a second angle θ2, and the second angle θ2 varies with the positions of the second hook portions 72 abutted against by the second pins 63. When the first hook portions 32 and the second hook portions 72 have identical irregular curvatures, and the angles of rotation of the first platform member 1 and the second platform member 5 are identical, a variation of the first angle θ1 and a variation of the second angle θ2 are identical. When the first platform member 1 and the second platform member 5 transform from the unfolded state to the folded state, the first angle θ1 and the second angle θ2 gradually increase, whereas when they transform from the folded state to the unfolded sate, the first angle θ1 and the second angle θ2 gradually decrease.

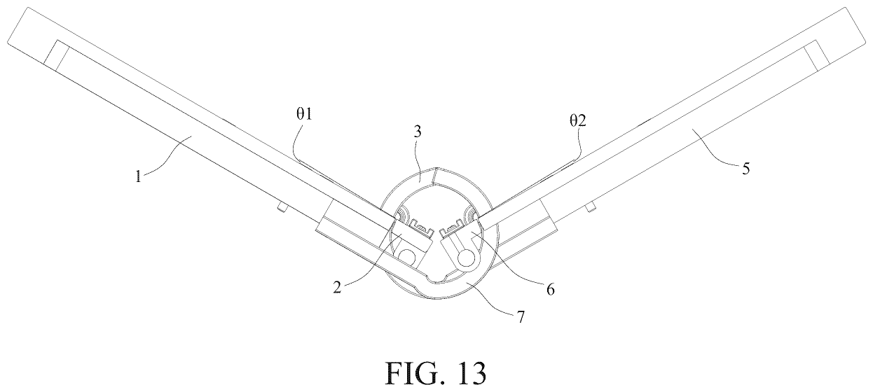

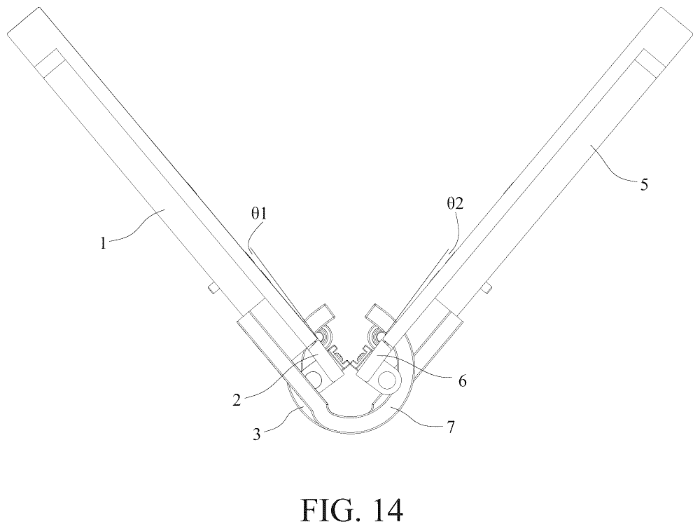

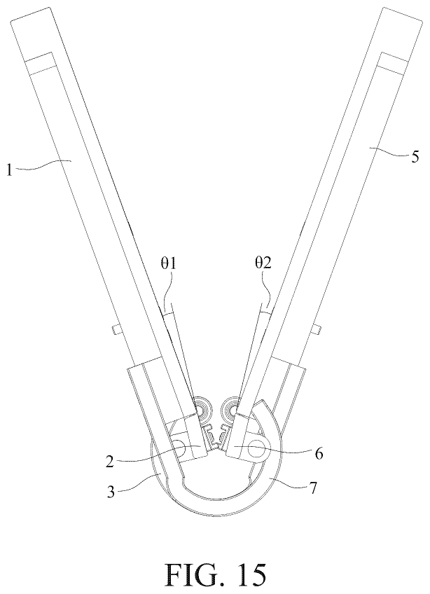

In an embodiment, as shown in FIG. 13, when the first platform member 1 and the second platform member 5 are respectively rotated by 30 degrees from the unfolded state to the folded state, so as to be a first intermediate state, the first angle θ1 and the second angle θ2 are 6.2 degrees. As shown in FIG. 14, when the first platform member 1 and the second platform member 5 are respectively rotated by 50 degrees from the unfolded state to the folded state, so as to be a second intermediate state, the first angle θ1 and the second angle θ2 are 8.7 degrees. As shown in FIG. 15, when the first platform member 1 and the second platform member 5 are respectively rotated by 70 degrees, so as to be a third intermediate state, the first angle θ1 and the second angle θ2 are 9.7 degrees.

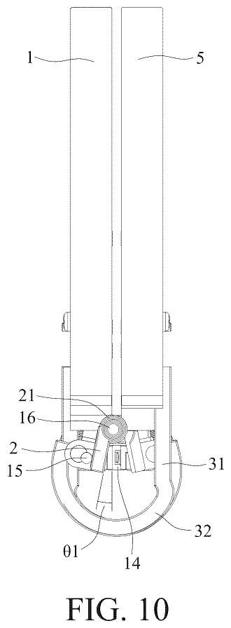

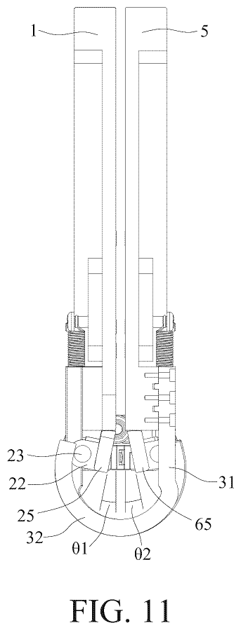

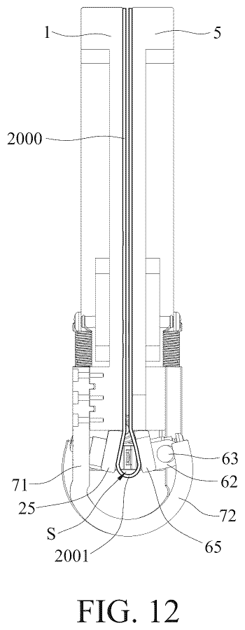

When the first platform member 1 and the second platform member 5 are respectively rotated by 90 degrees, so as to be the folded state, the first angle θ1 and the second angle θ2 are 10 degrees. At this time, the first platform member 1 and the second platform member 5 are adjacent to and are parallel to each other, the first drop plate 2 abuts against the first stop rods 15 and is away from the first stop blocks 14 (FIG. 10), the second drop plate 6 abuts against the second stop rods 55 and is away from the second stop blocks 54 (FIG. 9), the first pins 23 abut against ends of the first hook portions 32 being away from the first fixing portions 31 (FIG. 11), and the second pins 63 abut against ends of the second hook portions 72 being away from the second fixing portions 71 (FIG. 12).

Since the first hook portions 32 and the second hook portions 72 have irregular curvatures, the first angle θ1 and the second angle θ2 vary non-linearly. In other words, specific values of the first angle θ1 and the second angle θ2 can be obtained by adjusting the curvature of different sections of the first hook portions 32 and the second hook portions 72.

As shown in FIG. 12, when the first platform member 1 and the second platform member 5 are in the folded state, a distance between the first platform member 1 and the second platform member 5 is equal to a distance between one end of the first drop plate 2 adjacent to the first platform member 1 and one end of the second drop plate 6 adjacent to the second platform member 5. Due to existing of the first angle θ1 and the second angle θ2, a distance between the first platform member 1 and the second platform member 5 is less than a distance between one end of the first drop plate 2 away from the first platform member 1 and one end of the second drop plate 6 away from the second platform member 5, such that the first drop plate 2 and the second drop plate 6 jointly define an accommodation space S.

In the unfolded state of the test fixture 1000 according to the present disclosure, a flexible screen 2000 having a bendable area 2001 can be carried by upper surfaces of the first platform member 1, the second platform member 5, the first drop plate 2 and the second drop plate 6. In the folded state of the test fixture 1000, the bendable area 2001 is bent and is accommodated in the accommodation space S, as shown in FIG. 12, and the bendable area 2001 has a water drop shape.

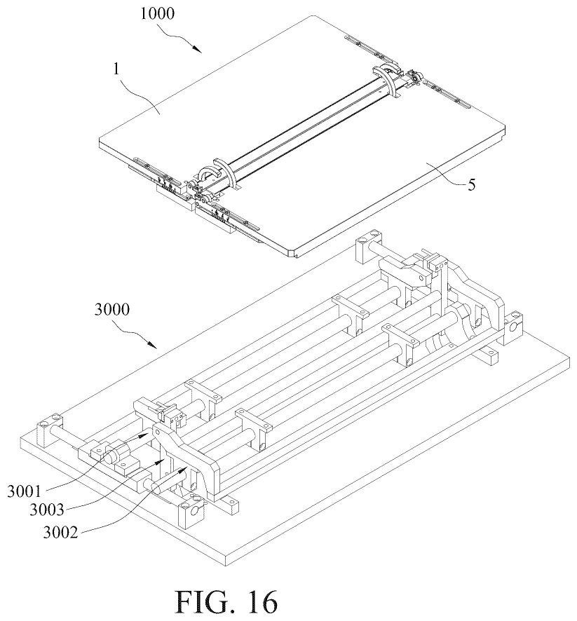

When the flexible screen 2000 is carried by the test fixture 1000 according to the present disclosure, the test fixture 1000 can repeatedly transform between the unfolded state and the folded state, so that a lifespan of the flexible screen 2000 is tested. As shown in FIG. 16, the test fixture 1000 can repeatedly perform the transformation via a driving platform 3000. The driving platform 3000 includes a first carrying portion 3001, a second carrying portion 3002 and a synchronizing portion 3003. The first carrying portion 3001 contacts a bottom side of the first platform member 1, the second carrying portion 3002 contacts a bottom side of the second platform member 5, and the synchronizing portion 3003 synchronizes the first carrying portion 3001 and the second carrying portion 3002. When the synchronizing portion 3003 moves downward, the first carrying portion 3001 clockwise rotates to transform the first platform member 1 from the unfolded state to the folded state, the second carrying portion 3002 counterclockwise rotates to transform the second platform member 5 from the unfolded state to the folded state, and vice versa.

To sum up, when the first platform member and the second platform member are rotated at different angles, the first angle and the second angle correspond to specific values in manners of the first hook portion and the second hook portion being designed with irregular curvatures, and the first pin and the second pin being continuously abutting against the first hook portion and the second hook portion via the first elastic elements and the second elastic elements. Accordingly, the test fixture of the present disclosure can effectively test a lifespan of a flexible screen, and the customized design of the irregular curvatures of the first hook portion and the second hook portion can accommodate the flexible screen in different bending conditions.

What is claimed is:

1. A test fixture for testing a lifespan of a flexible screen, the test fixture comprising:
a first platform member including at least one first pivot portion and at least one first slot;
a first drop plate pivotally connected to the first pivot portion, being rotatable relative to the first platform member, and including at least one first pin;
a second platform member including at least one second pivot portion and at least one second slot;
a second drop plate adjacent to the first drop plate, pivotally connected to the second pivot portion, being rotatable relative to the second platform member, and including at least one second pin;
at least one first limiting member fixedly connected to the second platform member and passing through the first slot, wherein the first pin abuts against the first limiting member; and
at least one second limiting member fixedly connected to the first platform member and passing through the second slot, wherein the second pin abuts against the second limiting member;
wherein the first platform member and the second platform member are transformable between an unfolded state and a folded state, wherein when the first platform member and the second platform member are in the unfolded state, the first platform member, the second platform member, the first drop plate and the second drop plate are flush with each other, wherein when the first platform member and the second platform member are in the folded state, the first platform member and the second platform member are adjacent to and are parallel to each other, the first drop plate and the first platform member are obliquely intersected at a first angle, and the second drop plate and the second platform member are obliquely intersected at a second angle.

2. The test fixture of claim 1, wherein when the first platform member and the second platform member transform from the unfolded state to the folded state, the first angle and the second angle gradually increase, and wherein when the first platform member and the second platform member transform from the folded state to the unfolded state, the first angle and the second angle gradually decrease.

3. The test fixture of claim 2, further comprising at least one first elastic element and at least one second elastic element, wherein opposite ends of the first elastic element are respectively fixedly connected to the first platform member and the first drop plate to constantly provide a first elastic force, and wherein opposite ends of the second elastic element are respectively fixedly connected to the second platform member and the second drop plate to constantly provide a second elastic force.

4. The test fixture of claim 3, wherein the first limiting member includes a first fixing portion and a first hook portion, the first fixing portion is fixedly connected to the second platform member, the first hook portion is formed by extending outward from the first fixing portion and bending to pass through the first slot, and the first elastic force keeps the first pin continuously abutting against the first hook portion, and wherein the second limiting member includes a second fixing portion and a second hook portion, the second fixing portion is fixedly connected to the first platform member, the second hook portion is formed by extending outward from the second fixing portion and bending to pass through the second slot, and the second elastic force keeps the second pin continuously abutting against the second hook portion.

5. The test fixture of claim 4, wherein the first platform member further includes at least one first stop block and at least one first stop rod, the first stop block is adjacent to the first pivot portion, and the first stop rod and the first stop block are spaced apart from each other, wherein the second platform member further includes at least one second stop block and at least one second stop rod, the second stop block is adjacent to the second pivot portion, the second stop rod and the second stop block are spaced apart from each other, wherein when the first platform member and the second platform member are in the unfolded state, the first drop plate abuts against the first stop block, and the second drop plate abuts against the second stop block, and wherein when the first platform member and the second platform member are in the folded state, the first drop plate abuts against the first stop rod, and the second drop plate abuts against the second stop rod.

6. The test fixture of claim 5, wherein the first hook portion and the second hook portion respectively include an irregular curvature, depending on different angles of rotation of the first platform member or the second platform member from the unfolded state to the folded state, the first pin or the second pin abuts against different positions of the first hook portion or the second hook portion, whereby the first angle or the second angle varies non-linearly.

7. The test fixture of claim 6, wherein when the first platform member and the second platform member are respectively rotated by 30 degrees from the unfolded state to the folded state, the first angle and the second angle are 6.2 degrees, wherein when the first platform member and the second platform member are respectively rotated by 50 degrees from the unfolded state to the folded state, the first angle and the second angle are 8.7 degrees, wherein when the first platform member and the second platform member are respectively rotated by 70 degrees from the unfolded state to the folded state, the first angle and the second angle are 9.7 degrees, and wherein when the first platform member and the second platform member are respectively rotated by 90 degrees from the unfolded state to be in the folded state, the first angle and the second angle are 10 degrees.

8. The test fixture of claim 7, wherein the first elastic element and the second elastic element are tension springs.

9. The test fixture of claim 1, wherein in the folded state, a distance between the first platform member and the second platform member is equal to or less than a distance between the first drop plate and the second drop plate.

10. The test fixture of claim 9, wherein the flexible screen is disposed on the first platform member, the first drop plate, the second platform member and the second drop plate, wherein the flexible screen includes a bendable area, and wherein when the first platform member and the second platform member are in the folded state, the bendable area of the flexible screen is bent, and the first drop plate and the second drop plate jointly define an accommodation space to accommodate the bendable area.

11. The test fixture of claim 10, wherein the bendable area has a water drop shape.
